(19) United States
(12) Patent Application Publication
(10) Pub. No.: US 2020/0028260 A1
(43) Pub. Date: Jan. 23, 2020

(54) METHOD AND APPARATUS FOR WIRELESS SYSTEMS

(71) Applicant: Metawave Corporation, Palo Alto, CA (US)

(72) Inventor: Maha ACHOUR, Encinitas, CA (US)

(21) Appl. No.: 16/517,525

(22) Filed: Jul. 19, 2019

Related U.S. Application Data
(60) Provisional application No. 62/700,706, filed on Jul. 19, 2018.

(51) Int. Cl. H01Q 3/34; H01Q 21/06; H01Q 13/10; H01Q 1/36; G01S 7/03; G01S 13/42

(52) U.S. Cl. CPC H01Q 3/34; H01Q 21/064; G01S 13/426; H01Q 1/364; G01S 7/03; H01Q 13/10

(57) ABSTRACT

Examples disclosed herein relate to a receive antenna array using main and side lobe portions to enhance object detection in a radar system. The receive antenna array includes an array of radiating elements and an antenna controller. The antenna controller determines portions of a radiation pattern of the array of radiating elements in response to detection of an object. The antenna controller also determines a directivity of a transmission from the array of radiating elements to increase gain of the transmission in a direction of the object based on the one or more portions of the radiation pattern. In some aspects, the portions includes a first portion of the radiation pattern that corresponds to a main lobe, a second portion that corresponds to at least one side lobe portion and a third portion that corresponds to an overlapping area of the main lobe and the at least one side lobe.

### CROSS-REFERENCE TO RELATED APPLICATIONS

This application claims priority from U.S. Provisional Application No. 62/700,706, filed on July 19, 2018, and incorporated by reference in its entirety.

### BACKGROUND

Wireless communications are used in an ever-expanding range of products with efficiency requirements. In a wireless transmission system, such as radar or cellular communications, the size of the antenna is determined by the transmission characteristics. With the widespread application of wireless applications, the footprint and other parameters allocated for a given antenna, or radiating structure, are constrained. In addition, the demands on the capabilities of the antenna continue to increase, such as, among others, increased bandwidth, finer control, and increased range. In these applications, there is a desire to reduce the power consumption, spatial footprint and computing power for operation of the antenna and transmission structure.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 conceptually illustrates a radar system, according to various implementations of the subject technology;

FIGS. 2A and 2B conceptually illustrate operation of transmit and receive radar antennas in a first scan configuration, according to various implementations of the subject technology;

FIGS. 3A and 3B conceptually illustrate operation of transmit and receive radar antennas in a second scan configuration, according to various implementations of the subject technology;

FIGS. 4A and 4B conceptually illustrate operation of transmit and receive radar antennas in a third scan configuration, according to various implementations of the subject technology;

FIGS. 5A and 5B conceptually illustrate operation of transmit and receive radar antennas in a fourth scan configuration, according to various implementations of the subject technology;

FIG. 6 illustrates radiation patterns for receive antennas, according to various implementations of the subject technology;

FIG. 7 illustrates a flow chart of an example process for operating a receive antenna in a radar system, according to various implementations of the subject technology;

FIG. 8 illustrates an antenna system, according to various implementations of the subject technology;

FIG. 9 illustrates an exploded view of the radiating structure, according to various implementations of the subject technology;

FIG. 10 illustrates a cross-sectional schematic diagram of the feed distribution module that provides a corporate feed propagating return signals received from superelements to an antenna system for processing, according to various implementations of the subject technology; and

FIG. 11 illustrates a radar system having an antenna system and a control system, according to various implementations of the subject technology.

### DETAILED DESCRIPTION

The present disclosure provides for wireless systems and radar systems, where information is transmitted via electromagnetic waves for communication and object detection. These transmissions have a main beamform and side lobe(s), in which each beamform has a gain associated therewith. In some aspects, the main beamform is directed in a first direction and the side lobes are directed in separate directions different from that of the main beamform. At a receive antenna, the side lobes may be used to enhance the detection capability of the wireless and radar systems.

The present disclosure also provides for radiating a signal, such as for radar or wireless communications, using a lattice array of radiating elements, a transmission array and a feed structure. The feed structure distributes a transmission signal throughout the transmission array, in which the transmission signal propagates along the rows of the transmission array and discontinuities are positioned along each row. This portion of the transmission array structure is a radiating portion of super elements that feed transmission signals to a lattice array of radiating elements, such as, for example, meta-structure unit cells. Within the super elements, the discontinuities (or slots) are positioned to correspond to radiating elements of the lattice array. In this way, there are multiple layers of radiating elements, including the super element layer and the meta-structure layer(s). A meta-structure (MTS), as generally defined herein, is an engineered, non- or semi-periodic structure that is spatially distributed to meet a specific phase and frequency distribution. In some implementations, the meta-structures include metamaterials.

The radiating elements are coupled to an antenna controller that applies voltages to the radiating elements to change their electromagnetic characteristics. This change may be an effective change in capacitance that acts to shift the phase of the transmission signal. By phase shifting the signal from individual radiating elements, the system forms a specific beam in a specific direction. The various slot configurations achieve different results and may be used with specific frequency bands. Some of these configurations may be used in combination with each other, such as to have one configuration of super elements for identifying one type of object and a second configuration of super elements for identifying a second type of object. In some implementations, the multiple configurations of super elements are presented in a layer within an antenna system and operate according to circuitry designed to optimize object identification in a radar system.

The present disclosure also provides for construction of multiple layers acting as a feed to a radiating layer. Transmission signals are provided from a power divider circuit as Substrate Integrated Waveguides (SIWs), in which the transmission signals first propagate through an aperture layer that is an SIW having apertures positioned within the layer. The apertures are formed by large slots in the aperture layer. These apertures are positioned to correlate to a layer of transmission lines having slots configured along the length of the transmission lines. This second layer is proximate to the aperture layer; however, the second layer is not directly coupled to the power divider circuit or distributed feed network. The radiating layer is proximate to the second layer, or to the super element layer. The transmission signals propagating through the super elements in the super element layer are radiated to the radiating layer through the slots on the super element layer. The aperture layer distributes the transmission signal in a manner that reduces the distortions of radiated signals, such as squint.

The transmission array and radiating layers may be fed from multiple sides, such as orthogonal feed distribution networks. In this way, beam steering is supported in multiple dimensions. There may also be additional aperture layers for a multi-layer stack, in which the transmission signals may be fed into one or more layers in a variety of methods.

In some implementations, a radar system steers a highly-directive Radio Frequency (RF) beam that can accurately determine the location and speed of road objects. The subject technology is not prohibited by weather conditions or clutter in an environment. The subject technology can provide performance similar to that of Synthetic Aperture Radar (SAR) capability. The subject technology uses radar to provide information for two-dimensional (2D) image capability as they measure range and azimuth angle, providing distance to an object and azimuth angle identifying a projected location on a horizontal plane, respectively, without the use of traditional large antenna elements.

The subject technology is applicable in wireless communication and radar applications, and in particular those incorporating meta-structures capable of manipulating electromagnetic waves using engineered radiating structures. For example, the present disclosure provides for antenna structures having MTS elements and arrays. There are structures and configurations within a feed network to the metamaterial elements that increase performance of the antenna structures in many applications, including vehicular radar modules. Additionally, the present disclosures provide methods and apparatuses for generating wireless signals, such as radar signals, having improved directivity, reduced undesired radiation patterns aspects, such as side lobes. The present disclosures provide antennas with unprecedented capability of generating RF waves for radar systems. These disclosures provide improved sensor capability and support autonomous driving by providing one of the sensors used for object detection. The disclosures are not limited to these applications and may be readily employed in other antenna applications, such as wireless communications, 5G cellular, fixed wireless and so forth.

The subject technology relates to smart active antennas with unprecedented capability of manipulating RF waves to scan an entire environment in a fraction of the time of current systems. The subject technology also relates to smart beam steering and beam forming using MTS radiating structures in a variety of configurations, in which electrical changes to the antenna are used to achieve phase shifting and adjustment reducing the complexity and processing time and enabling fast scans of up to approximately 360° field of view for long range object detection.

The present disclosure provides for methods and apparatuses for radiating structures, such as for radar and cellular antennas, and provide enhanced phase shifting of the transmitted signal to achieve transmission in the autonomous vehicle communication and detection spectrum, which in the US is approximately 77 GHz and has a 5 GHz range, specifically, 76 GHz to 81 GHz, to reduce the computational complexity of the system, and to increase the transmission speed. The present disclosure accomplishes these goals by taking advantage of the properties of hexagonal structures coupled with novel feed structures. In some implementations, the present disclosure accomplishes these goals by taking advantage of the properties of MTS elements coupled with novel feed structures.

Metamaterials derive their unusual properties from structure rather than composition and they possess exotic properties not usually found in nature. The metamaterials are structures engineered to have properties not found in nature. The metamaterial antennas may take any of a variety of forms, some of which are described herein for comprehension; however, this is not an exhaustive compilation of the possible implementations of the present disclosure. Metamaterials are typically arranged in repeating patterns. For antennas, metamaterials may be built at scales much smaller than the wavelengths of transmission signals radiated by the metamaterial. Metamaterial properties come from the engineered and designed structures rather than from the base material forming the structures. Precise shape, dimensions, geometry, size, orientation, arrangement and so forth result in the smart properties capable of manipulating EM waves by blocking, absorbing, enhancing, or bending waves.

The subject technology supports autonomous driving with improved sensor performance, all-weather/all-condition detection, advanced decision-making algorithms and interaction with other sensors through sensor fusion. These configurations optimize the use of radar sensors, as radar is not inhibited by weather conditions in many applications, such as for self-driving cars. The ability to capture environmental information early aids control of a vehicle, allowing anticipation of hazards and changing conditions. The sensor performance is also enhanced with these structures, enabling long-range and short-range visibility to the controller. In an automotive application, short-range is considered within 30 meters of a vehicle, such as to detect a person in a cross walk directly in front of the vehicle; and long-range is considered to be 250 meters or more, such as to detect approaching cars on a highway. The present disclosure provides for automotive radar sensors capable of reconstructing the world around them and are effectively a radar “digital eye,” having true 3D vision and capable of human-like interpretation of the world.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology. In other instances, well-known methods and structures may not be described in detail to avoid unnecessarily obscuring the description of the examples. Also, the examples may be used in combination with each other.

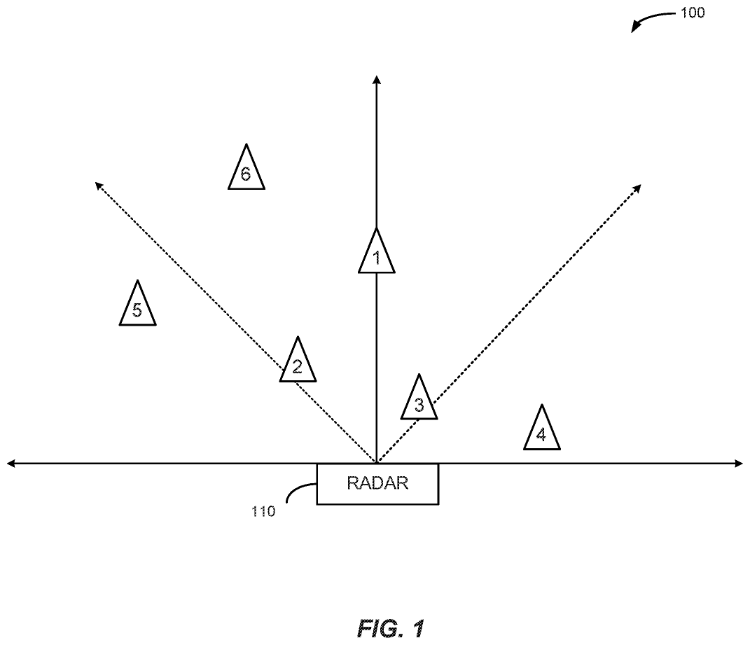

FIG. 1 conceptually illustrates a radar system 100, according to various implementations of the subject technology. The radar system 110 is positioned to detect multiple objects (depicted as objects 1-6) in its path in an environment 100. The radar system 100 includes a transmit module with a transmit antenna, in which the transmit module is identified as Tx. The radar system 100 also includes a receive module with a receive antenna, in which the receive module is identified as Rx. The transmit and receive modules may be configured in a single module or distributed among multiple modules. In some implementations, portions of the transmit and receive chains within the transmit and receive modules, respectively, are shared. In some implementations, the transmit and receive antennas are separate portions of a similar antenna, such as subarrays within an array of radiating elements. The transmit antenna transmits a radiating signal at a transmit angle, in which the transmitted radiating signal has a main lobe and side lobes. Each side lobe of the transmitted radiated signal may have a corresponding directional angle measured from a boresight position as a reference.

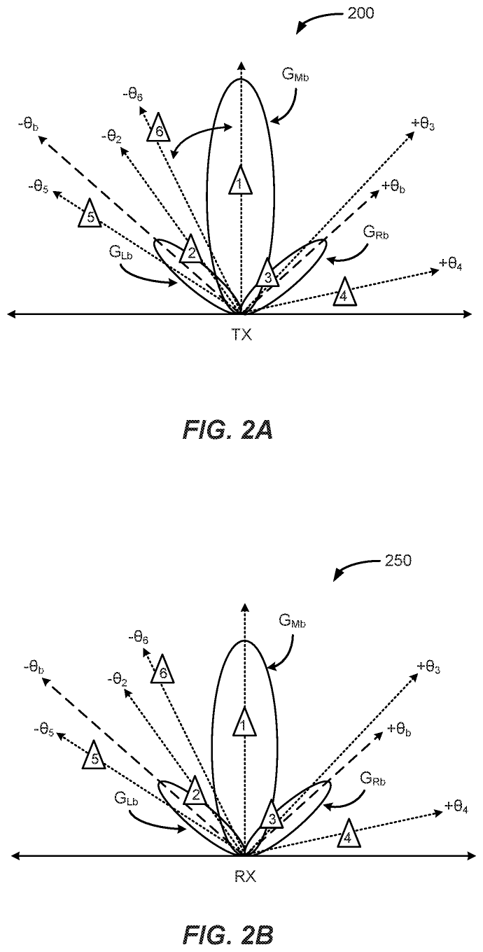

FIGS. 2A and 2B conceptually illustrate operation of transmit and receive radar antennas in a first scan configuration, according to various implementations of the subject technology. FIG. 2A illustrates a radiation pattern 200 of a fixed transmit signal that is transmitted by a transmit antenna. The radiation pattern 200 includes a main lobe (depicted as “G_{Mb}”), a right-side lobe (depicted as “G_{Rb}”) and a left-side lobe (depicted as “G_{Lb}”). The main lobe has a first gain (depicted as “G_{Mb}”) with a first radial distance from the transmit antenna, the left-side lobe has a second gain smaller than the first gain (depicted as “G_{Lb}”) with a third radial distance from the transmit antenna and the right-side lobe has a third gain smaller than the first gain (depicted as “G_{Rb}”) with a third radial distance from the transmit antenna. In this respect, the second radial distance is greater than the third radial distance, and the first radial distance is greater than the second radial distance. In some implementations, the gain of the left-side lobe is substantially equivalent to that of the right-side lobe. As depicted in FIG. 2A, the main lobe of the transmit radiation pattern is directed at boresight while scanning receive signals (see FIG. 2B) so as to detect all six objects.

FIG. 2B illustrates a radiation pattern 250 emitted by a receive antenna. The radiation pattern 250 of the receive antenna is similar to that of the transmit antenna depicted in FIG. 2A. For example, the radiation pattern 250 includes a main lobe that has a first gain (depicted as “G_{Mb}”) with a first radial distance from the receive antenna, a left-side lobe that has a second gain smaller than the first gain (depicted as “G_{Lb}”) with a third radial distance from the receive antenna and a right-side lobe that has a third gain smaller than the first gain (depicted as “G_{Rb}”) with a third radial distance from the receive antenna. In this respect, the second radial distance is greater than the third radial distance, and the first radial distance is greater than the second radial distance. In the first scan configuration, the radiation pattern 250 of the receive antenna has a main lobe directed at boresight. In this example, the receive antenna can detect object 1 through the main lobe and objects 2 and 3 through the left-side lobe and right side lobe, respectively. However, the receive antenna may not detect objects 4, 5 and 6 based at least on the main and side lobes not detecting the return RF beams of these objects. Table 1 (shown below) provides a listing of gain and angular positions of the transmit and receive antennas; and also provides the detected parameters of each of the lobes for the first scan configuration.

TABLE 1
Gain and Angular Positions for First Scan Configuration

| Transmit Angle | | | Receive Angle | | | Transmit Gain | | | Receive Gain | | |
|---|---|---|---|---|---|---|---|---|---|---|---|
| M | R | L | M | R | L | M | R | L | M | R | L |
| 0 | +θb | −θb | 0 | +θb | −θb | G_{MB} | G_{Rb} | G_{Lb} | G_{Mb} | G_{Rb} | G_{Lb} |

| | Detected w/ | | | Detected w/ | | | Detected w/ | | | |
|---|---|---|---|---|---|---|---|---|---|---|
| Object | Main Lobe | | | Right Lobe | | | Left Lobe | | | |
| Index | AoA | Range | Vel. | AoA | Range | Vel. | AoA | Range | Vel. | Total SNR |
| 1 | 0 | R₁ | V₁ | — | — | — | — | — | — | G_{Mb} |
| 2 | −θ₂ | R₂ | V₂ | — | — | — | −θ₂ | R₂ | V₂ | G_{Mb} + G_{Lb} |
| 3 | +θ₃ | R₃ | V₃ | +θ₃ | R₃ | V₃ | — | — | — | G_{Mb} + G_{Rb} |
| 4 | — | — | — | — | — | — | — | — | — | — |
| 5 | — | — | — | — | — | — | — | — | — | — |
| 6 | — | — | — | — | — | — | — | — | — | — |

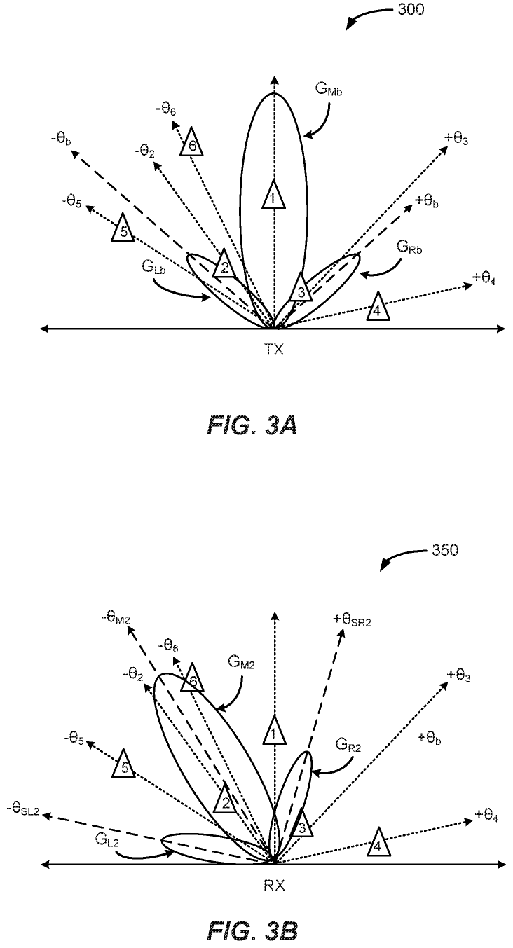

FIGS. 3A and 3B conceptually illustrate operation of transmit and receive radar antennas in a second scan configuration, according to various implementations of the subject technology. FIG. 3A illustrates a radiation pattern 300 of a fixed transmit signal that is transmitted by a transmit antenna, and FIG. 3B illustrates a radiation pattern 350 emitted by a receive antenna. The radiation pattern 350 of the receive antenna is different from that of the transmit antenna depicted in FIG. 3A. In the second scan configuration, the radiation pattern 350 of the receive antenna has a main lobe directed at −θ_{M2}. In this example, the receive antenna can detect objects 2 and 6 through the main lobe and object 3 through the right-side lobe. However, the receive antenna may not detect objects 1, 4 and 5 based at least on the main and side lobes not detecting the return RF beams of these objects. Table 2 (shown below) provides a listing of gain and angular positions of the transmit and receive antennas; and also provides the detected parameters of each of the lobes for the second scan configuration.

TABLE 2
Gain and Angular Positions for Second Scan Configuration

| Transmit Angle | | | Receive Angle | | | Transmit Gain | | | Receive Gain | | |
|---|---|---|---|---|---|---|---|---|---|---|---|
| M | R | L | M | R | L | M | R | L | M | R | L |
| 0 | +θb | −θb | −θ_{M2} | +θ_{SR2} | −θ_{SL2} | G_{Mb} | G_{Rb} | G_{Lb} | G_{M2} | G_{R2} | G_{L2} |

| | Detected w/ | | | Detected w/ | | | Detected w/ | | | |
|---|---|---|---|---|---|---|---|---|---|---|
| Object | Main Lobe | | | Right Lobe | | | Left Lobe | | | |
| Index | AoA | Range | Vel. | AoA | Range | Vel. | AoA | Range | Vel. | Total SNR |
| 1 | — | — | — | — | — | — | — | — | — | — |
| 2 | −θ₂ | R₂ | V₂ | — | — | — | — | — | — | G_{M2} |
| 3 | — | — | — | +θ₃ | R₃ | V₃ | — | — | — | G_{R2} |
| 4 | — | — | — | — | — | — | — | — | — | — |
| 5 | — | — | — | — | — | — | — | — | — | — |
| 6 | −θ₆ | R₆ | V₆ | — | — | — | — | — | — | G_{M2} |

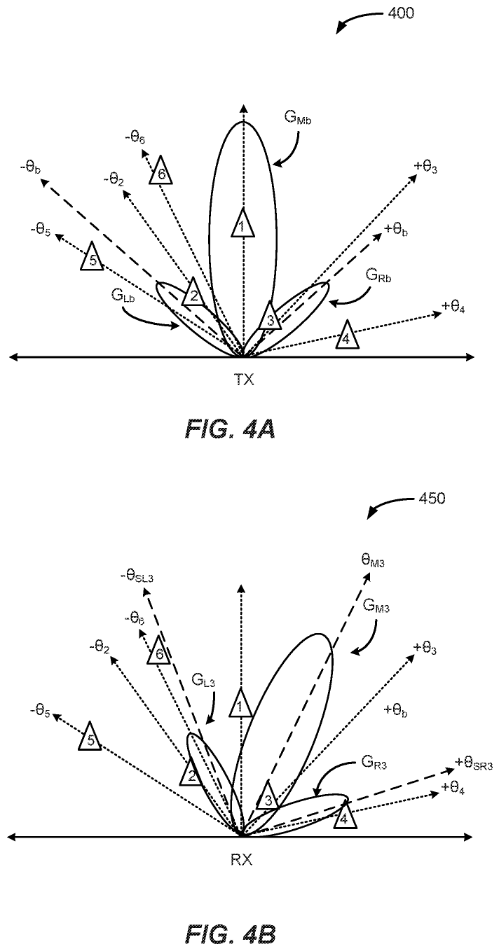

FIGS. 4A and 4B conceptually illustrate operation of transmit and receive radar antennas in a third scan configuration, according to various implementations of the subject technology. FIG. 4A illustrates a radiation pattern 400 of a fixed transmit signal that is transmitted by a transmit antenna, and FIG. 4B illustrates a radiation pattern 450 emitted by a receive antenna. The radiation pattern 450 of the receive antenna is different from that of the transmit antenna depicted in FIG. 4A. In the third scan configuration, the radiation pattern 450 of the receive antenna has a main lobe directed at +θ_{M3}. In this example, the receive antenna can detect object 3 through the main lobe, object 2 through the left-side lobe, and object 4 through the right-side lobe. However, the receive antenna may not detect objects 1, 5 and 6 based at least on the main and side lobes not detecting the return RF beams of these objects. Table 3 (shown below) provides a listing of gain and angular positions of the transmit and receive antennas; and also provides the detected parameters of each of the lobes for the third scan configuration. As indicated in Table 3, where an object is detected by both a main lobe and a side lobe, the gain of the detection beam is the sum of the two gains. This is the case with the detection of object 3 in FIG. 4B.

TABLE 3
Gain and Angular Positions for Third Scan Configuration

| Transmit Angle | | | Receive Angle | | | Transmit Gain | | | Receive Gain | | |
|---|---|---|---|---|---|---|---|---|---|---|---|
| M | R | L | M | R | L | M | R | L | M | R | L |
| 0 | +θb | −θb | +θ_{M3} | +θ_{SR3} | −θ_{SL3} | G_{Mb} | G_{Rb} | G_{Lb} | G_{M2} | G_{R3} | G_{L3} |

| | Detected w/ | | | Detected w/ | | | Detected w/ | | | |
|---|---|---|---|---|---|---|---|---|---|---|
| Object | Main Lobe | | | Right Lobe | | | Left Lobe | | | |
| Index | AoA | Range | Vel. | AoA | Range | Vel. | AoA | Range | Vel. | Total SNR |
| 1 | — | — | — | — | — | — | — | — | — | — |
| 2 | — | — | — | — | — | — | −θ₂ | R₂ | V₂ | G_{L3} |
| 3 | +θ₃ | R₃ | V₃ | +θ₃ | R₃ | V₃ | — | — | — | G_{M3} + G_{R3} |
| 4 | — | — | — | +θ₄ | R₄ | V₄ | — | — | — | G_{R3} |
| 5 | — | — | — | — | — | — | — | — | — | — |
| 6 | — | — | — | — | — | — | — | — | — | — |

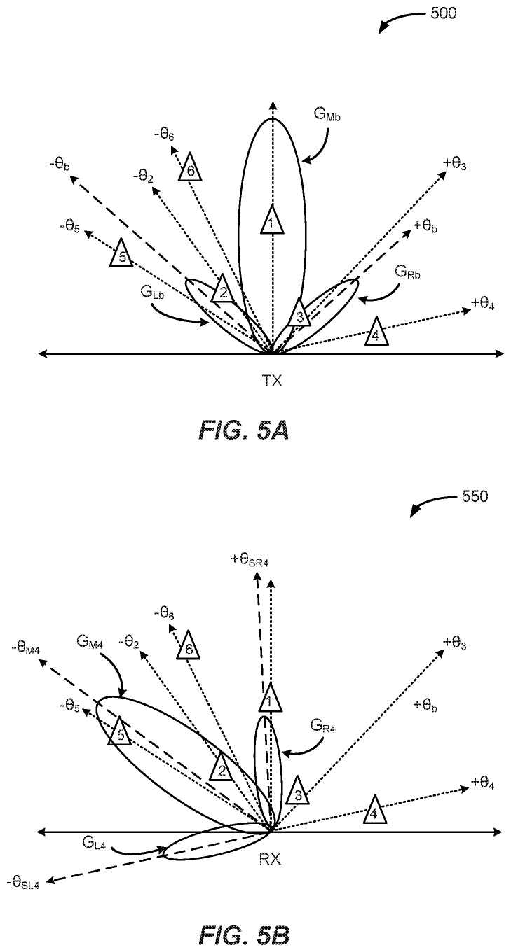

FIGS. 5A and 5B conceptually illustrate operation of transmit and receive radar antennas in a fourth scan configuration, according to various implementations of the subject technology. FIG. 5A illustrates a radiation pattern 500 of a fixed transmit signal that is transmitted by a transmit antenna, and FIG. 5B illustrates a radiation pattern 550 emitted by a receive antenna. The radiation pattern 550 of the receive antenna is different from that of the transmit antenna depicted in FIGS. 3A and 4A. In the fourth scan configuration, the radiation pattern 550 of the receive antenna has a main lobe directed at −θ_{M4}. In this example, the receive antenna can detect objects 2 and 5 through the main lobe, and no objects through the left-side and right-side lobes. However, the receive antenna may not detect objects 1, 3, 4 and 6 based at least on the main and side lobes not detecting the return RF beams of these objects. Table 4 (shown below) provides a listing of gain and angular positions of the transmit and receive antennas; and also provides the detected parameters of each of the lobes for the fourth scan configuration. In this respect, the four scan configurations enable the radar system 100 to detect all six objects.

TABLE 4
Gain and Angular Positions for Fourth Scan Configuration

| Transmit Angle | | | Receive Angle | | | Transmit Gain | | | Receive Gain | | |
|---|---|---|---|---|---|---|---|---|---|---|---|
| M | R | L | M | R | L | M | R | L | M | R | L |
| 0 | +θb | −θb | +θ_{M4} | −θ_{SR4} | −θ_{SL4} | G_{Mb} | G_{Rb} | G_{Lb} | G_{M4} | G_{R4} | G_{L4} |

| | Detected w/ | | | Detected w/ | | | Detected w/ | | | |
|---|---|---|---|---|---|---|---|---|---|---|
| Object | Main Lobe | | | Right Lobe | | | Left Lobe | | | |
| Index | AoA | Range | Vel. | AoA | Range | Vel. | AoA | Range | Vel. | Total SNR |
| 1 | — | — | — | — | — | — | — | — | — | — |
| 2 | +θ₂ | R₂ | V₂ | — | — | — | — | — | — | G_{M4} |
| 3 | — | — | — | — | — | — | — | — | — | — |
| 4 | — | — | — | — | — | — | — | — | — | — |
| 5 | +θ₅ | R₅ | V₅ | — | — | — | — | — | — | G_{M4} |
| 6 | — | — | — | — | — | — | — | — | — | — |

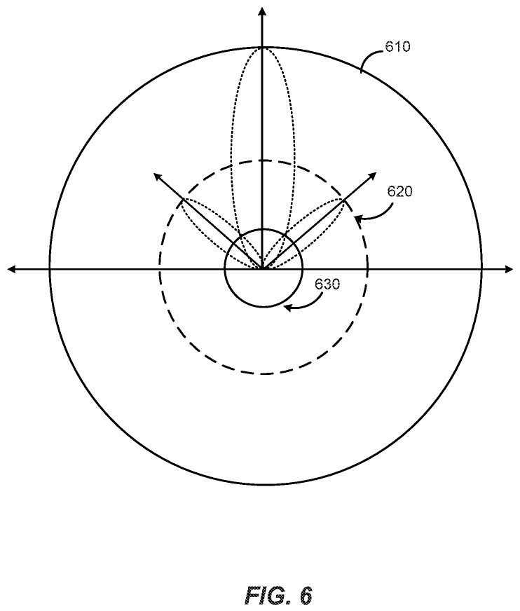

FIG. 6 illustrates radiation patterns for receive antennas, according to various implementations of the subject technology. The radiation patterns represent a pattern of coverage achievable with the receive antenna beamforms shown. As illustrated in FIG. 6, objects within an outer circle 610 may be detectable with a main lobe of the receive antenna, while objects within a middle circle 620 may be detectable by the side lobes of the receive antenna. An inner circle 630 defines an area within which objects may be detectable by an overlap of the main lobe with a side lobe.

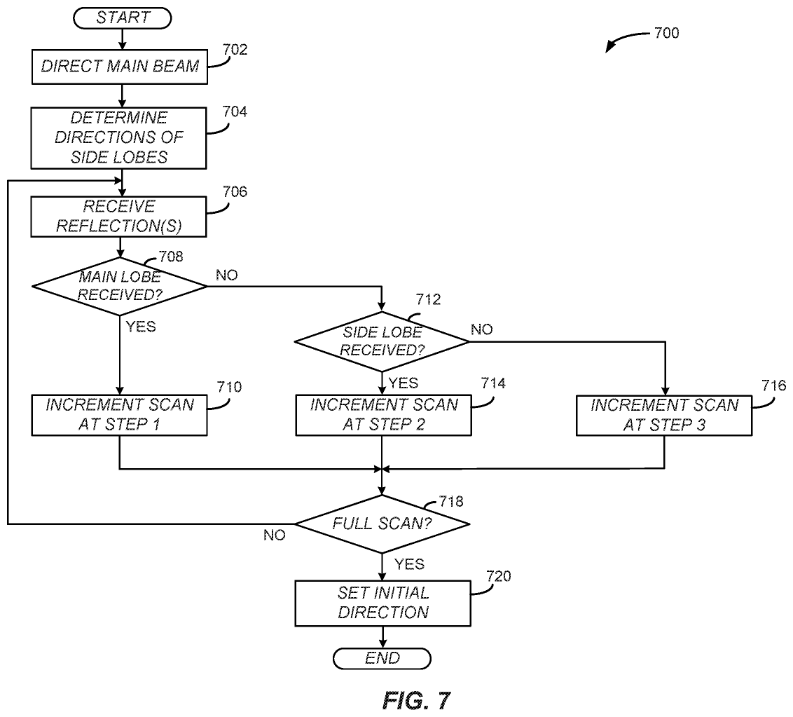

FIG. 7 illustrates a flow chart of an example process 700 for operating a receive antenna in a radar system, according to various implementations of the subject technology. For explanatory purposes, the example process 700 is primarily described herein with reference to the scanning system 100 of FIG. 1; however, the example process 700 is not limited to the radar system 100 of FIG. 1, and the example process 700 can be performed by one or more other components of the radar system 100 of FIG. 1. Further for explanatory purposes, the blocks of the example process 700 are described herein as occurring in serial, or linearly. However, multiple blocks of the example process 700 can occur in parallel. In addition, the blocks of the example process 700 can be performed in a different order than the order shown and/or one or more of the blocks of the example process 700 are not performed.

The example process 700 begins at step 702, where a radar system (e.g., the radar system 100 of FIG. 1) directs a main beam of a receive antenna to detect one or more return RF beams that are reflected from objects in a surrounding environment. Next, at step 704, the radar system 100 determines the directions and gains of the side lobes of the receive antenna. Subsequently, at step 706, the receive antenna of the radar system 100 receives the one or more return RF beams as reflections.

When a reflection is received, the process 700 determines which lobe(s) received the reflections. For example, at step 708, the radar system 100 determines whether the main lobe received the reflections. If the reflections were received by the main lobe, then the process 700 proceeds to step 710. Otherwise, the process 700 proceeds to step 712.

At step 710, when the reflections are received by the main lobe, the radar system 100 can increment the scan to a “Step 1,” which adjusts the direction of the main beam. In some aspects, the adjustment to the main lobe direction may be performed through phase shifting operations on the antenna elements. In some implementations, the process 700 may include a step for adjusting the main beam to focus more directly at the incoming reflection based on the range, velocity and angle of arrival (AoA) of the one or more return RF beams.

At step 712, the radar system 100 determines whether the side lobes received the reflections. If the reflections were received by the side lobes, then the process 700 proceeds to step 714. Otherwise, the process 700 proceeds to step 716. At step 714, when the reflections are received by a side lobe, the radar system 100 can increment the scan to a “Step 2,” which adjusts the direction of the main beam and the resultant side lobe directions. This adjustment may adjust the focus toward the detected object to accurately determine the range, velocity and AoA by directing the beam to maximize gain in the area of the object. In some implementations, the Step 2 may cause alignment of the side lobe with the direction of the object. In other implementations, the Step 2 may cause alignment of the main lobe with the direction of the object. In still other implementations, the Step 2 may cause alignment of an overlapping region of the main and side lobes with the direction of the object.

At step 716, when the reflections are received by an overlapped area of the main lobe and a side lobe, the radar system 100 can increment the scan to a “Step 3,” which adjusts the direction of the main beam and the resultant side lobe directions. The step size can be incremented based on the range, velocity and AoA. For example, where the range is relatively small (e.g., less than 100 meters), the radar system 100 may determine to direct an overlapped region of the receive antenna toward the object. In another example, where the range is relatively far (e.g., greater than 100 meters), the radar system 100 may direct the main lobe toward the object. In each case, the process 700 operates to maximize the gain of a radiation pattern of the receive antenna toward the object or anticipated position of the object.

Subsequently, at step 718, the radar system 100 determines whether a full scan has completed. If a full scan has not been completed, then the process 700 proceeds back to step 706. Otherwise, the process 700 proceeds to step 720. At step 720, the process 700 terminates the scan and sets the receive antenna to an initial direction when a full scan is completed. In some aspects, the initial direction may be a default direction or may be determined based on the detected object(s) of a previous scan.

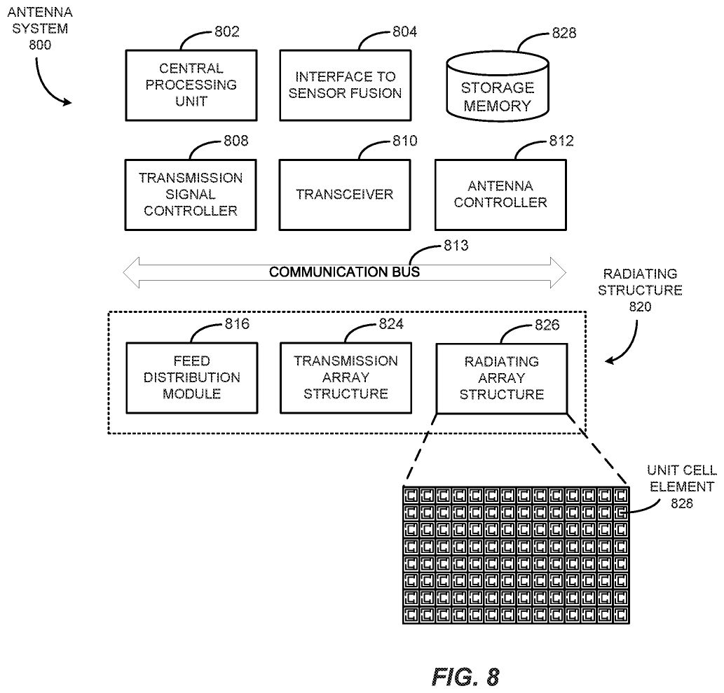

FIG. 8 illustrates an antenna system 800, according to implementations of the subject technology. The illustrated example of the antenna system 800 is not meant to be limiting, but rather to provide a full example of the application of the present disclosure. The present disclosure describes the flexibility and robust design of the subject technology in antenna and radar design. The concepts described herein are also applicable to other systems and other antenna structures. The disclosure presented herein, along with variations thereof, may be used in communication systems or other applications that incorporate radiating elements and feed structures.

The antenna system 800 includes a central processing unit 802, an interface-to-sensor fusion 804, a transmission signal controller 808, a transceiver 810, an antenna controller 812, and a memory storage unit 828. The antenna system 800 is communicably coupled to a radiating structure 820 through a communication bus 83. The radiating structure 820 includes a feed distribution module 816, a transmission array structure 824, and a radiating array structure 826. Not all of the depicted components may be used, however, and one or more implementations may include additional components not shown in the figure. Variations in the arrangement and type of the components may be made without departing from the scope of the claims set forth herein. Additional components, different components, or fewer components may be provided.

As in FIG. 8, the antenna system 800 includes interfaces with other modules, such as through the interface-to-sensor fusion 804, where information is communicated between the antenna system 800 and a sensor fusion module (not shown). The antenna controller 812 can control the generation and reception of electromagnetic radiation, or energy beams. The antenna controller 812 determines the direction, power and other parameters of the beams and controls the radiating structure 820 to achieve beam steering in various directions. In some implementations, the antenna controller 812 determines one or more portions of a radiation pattern of radiating elements in the radiating array structure 826 in response to detection of an object, and determines a directivity of a transmission from radiating elements in the radiating array structure 826 to increase gain of the transmission in a direction of the object based on the one or more portions of the radiation pattern. In some aspects, the one or more portions of the radiation pattern includes a first portion of the radiation pattern that corresponds to a main lobe, a second portion of the radiation pattern that corresponds to at least one side lobe and a third portion of the radiation pattern that corresponds to an overlapping area of the main lobe and the at least one side lobe. The antenna system 800 also includes modules for control of reactance, phase and signal strength in a transmission line.

The present disclosure is described with respect to a radar system, where the radiating structure 820 is a structure having a feed structure, such as the feed distribution module 816, with an array of transmission lines feeding a radiating array, such as the radiating array structure 826, through the transmission array structure 824. In some implementations, the transmission array structure 824 includes a plurality of transmission lines configured with discontinuities within the conductive material and the radiating structure 826 is a lattice structure of unit cell radiating elements proximate the transmission lines. The feed distribution module 816 may include a coupling module for providing an input signal to the transmission lines, or a portion of the transmission lines. In some implementations, the coupling module is a power divider circuit that divides the input signal among the plurality of transmission lines, in which the power may be distributed equally among the N transmission lines or may be distributed according to another scheme, such that the N transmission lines do not all receive a same signal strength.

In one or more implementations, the feed distribution module 816 incorporates a dielectric substrate to form a transmission path, such as a SIW. In this respect, the feed distribution module 816 may provide reactance control through integration with the transmission line, such as by insertion of a microstrip or strip line portion that couples to a reactance control mechanism (not shown). The feed distribution module 816 may enable control of the reactance of a fixed geometric transmission line. In some implementations, one or more reactance control mechanisms may be placed within a transmission line. Similarly, the reactance control mechanisms may be placed within multiple transmission lines to achieve a desired result. The reactance control mechanisms may have individual controls or may have a common control. In some implementations, a modification to a first reactance control mechanism is a function of a modification to a second reactance control mechanism.

In some implementations, the radiating structure 820 includes the power divider circuit and a control circuit therefor. The control circuit includes the reactance control mechanisms, or reactance controller, such as a variable capacitor, to change the reactance of a transmission circuit and thereby control the characteristics of the signal propagating through the transmission line. The reactance control mechanisms can act to change the phase of a signal radiated through individual antenna elements of the radiating array structure 826. Where there is such an interruption in the transmission line, a transition is made to maintain signal flow in the same direction. Similarly, the reactance control mechanisms may utilize a control signal, such as a Direct Current (DC) bias line or other control means, to enable the antenna system 800 to control and adjust the reactance of the transmission line. In some implementations, the feed distribution module 816 includes one or more structures that isolate the control signal from the transmission signal. In the case of an antenna transmission structure, the reactance control mechanisms may serve as the isolation structure to isolate DC control signal(s) from Alternating Current (AC) transmission signals.

The transmission line may have various portions, in which a first portion receives an transmission signal as an input, such as from a coaxial cable or other supply structure, and the transmission signal traverses a substrate portion to divide the transmission signal through a corporate feed-style network resulting in multiple transmission lines that feed multiple super elements. Each super element includes a transmission line having a plurality of slots. The transmission signal radiates through these slots in the super elements of the transmission array structure 824 to the radiating array structure 826, which includes an array of MTS elements positioned proximate the super elements. In some implementations, the array of MTS elements is overlaid on the super elements, however, a variety of configurations may be implemented. The super elements effectively feed the transmission signal to the array of MTS elements, from which the transmission signal radiates. Control of the array of MTS elements results in a directed signal or beamform.

As described in the present disclosure, a reactance control mechanism is incorporated to adjust the effective reactance of a transmission line and/or a radiating element fed by a transmission line. In some implementations, the reactance control mechanism includes a varactor that changes the phase of a signal. In other implementations, alternate control mechanisms are used. The reactance control mechanism may be, or include at least a portion of, a varactor diode having a bias voltage applied by a controller (not shown). The varactor diode may serve as a variable capacitor when a reverse bias voltage is applied. As used herein, the term “reverse bias voltage” is also referred to herein as “reactance control voltage” or “varactor voltage.” The value of the reactance, which in this case is capacitance, is a function of the reverse bias voltage value. By changing the reactance control voltage, the capacitance of the varactor diode is changed over a given range of values. Alternate implementations may use alternate methods for changing the reactance, which may be electrically or mechanically controlled. In some implementations, the varactor diode also may be placed between conductive areas of a radiating element. With respect to the radiating element, changes in varactor voltage produce changes in the effective capacitance of the radiating element. The change in effective capacitance changes the behavior of the radiating element and in this way the varactor diode may be considered as a tuning element for the radiating elements in beam formation.

In some implementations, the radiating array structure 826 is coupled to the antenna controller 812, the central processing unit 802, and the transceiver 810. The transmission signal controller 808 generates the specific transmission signal, such as a Frequency Modulated Continuous Wave (FMCW) signal, which is used as for radar sensor applications as the transmitted signal is modulated in frequency, or phase. The FMCW transmitter signal enables radar to measure range to an object by measuring the phase differences in phase or frequency between the transmitted signal and the received signal, or reflected signal. Other modulation types may be incorporated according to the desired information and specifications of a system and application. Within FMCW formats, there are a variety of modulation patterns that may be used within FMCW, including sinusoidal, triangular, sawtooth, rectangular and so forth, each having advantages and purposes. For example, sawtooth modulation may be used for large distances to a target; a triangular modulation enables use of the Doppler frequency, and so forth. The received information is stored in the memory storage unit 828, in which the information structure may be determined by the type of transmission and modulation pattern. Other modulation schemes may be employed to achieve desired results. The transmission signal controller 808 may generate a cellular modulated signal, such as an Orthogonal Frequency Division Multiplexing (OFDM) signal. The transmission feed structure may be used in a variety of systems. In some systems, the transmission signal is provided to the antenna system 800 and the transmission signal controller 808 may act as an interface, translator or modulation controller, or otherwise as required for the transmission signal to propagate through a transmission line network of the feed distribution module 816.

Continuing with FIG. 8, the radiating structure 820 includes the radiating array structure 826, composed of individual radiating elements discussed herein. The radiating array structure 826 may take a variety of forms and is designed to operate in coordination with the transmission array structure 824, in which individual radiating elements, depicted as unit cell element 828, correspond to elements within the transmission array structure 824. As used herein, the “unit cell element” is referred to as an “MTS unit cell” or “MTS element,” and these terms are used interchangeably throughout the present disclosure without departing from the scope of the subject technology. The MTS unit cells include a variety of conductive structures and patterns, such that a received transmission signal is radiated therefrom. The MTS unit cell may serve as an artificial material, meaning a material that is not naturally occurring. Each MTS unit cell has some unique properties. These properties include a negative permittivity and permeability resulting in a negative refractive index; these structures are commonly referred to as left-handed materials (LHM). The use of LHM enables behavior not achieved in classical structures and materials. The MTS array is a periodic arrangement of unit cells that are each smaller than the transmission wavelength. One implementation is illustrated in which the radiating array structure 826 is an 8×86 cell array, in which each of the unit cell elements 828 has a uniform size and shape; however, alternate and other implementations may incorporate different sizes, shapes, configurations and array sizes.

As seen in the present disclosure, interesting effects may be observed in propagation of electromagnetic waves, or transmission signals. Metamaterials can be used for several interesting devices in microwave and terahertz engineering such as antennas, sensors, matching networks, and reflectors, such as in telecommunications, automotive and vehicular, robotic, biomedical, satellite and other applications.

In some implementations, the feed distribution module 816 includes a capacitance control mechanism controlled by the antenna controller 812 to control the phase of a transmission signal as it radiates from radiating array structure 826. In some implementations, the antenna controller 812 determines a voltage matrix to apply to the reactance control mechanisms within the reactance control mechanism to achieve a given phase shift or other antenna parameters. In some implementations, the radiating array structure 826 is adapted to transmit a directional beam without incorporating digital beam forming techniques, but rather through active control of the reactance parameters of the individual unit cell elements 828 that make up the radiating array structure 826.

In a radar implementation, the antenna controller 812 receives information from within the antenna system 800. As illustrated in FIG. 8, information is provided from the radiating structure 820 and from the interface-to-sensor fusion 804 to a sensor fusion module (not shown). This implementation depicts a vehicular control system, but is applicable in other fields and applications as well. In a vehicular control system, the sensor fusion module can receive information (digital and/or analog form) from multiple sensors and can interpret that information, making various inferences and initiating actions accordingly. One such action is to provide information to the antenna controller 812, in which that information may be the sensor information or may be an instruction to respond to sensor information. The sensor information may provide details of an object detected by one or more sensors, including the object's range, velocity, acceleration, and so forth. The sensor fusion module may detect an object at a location and instruct the antenna controller 812 to focus a beam on that location. The antenna controller 812 then responds by controlling the transmission beam through the reactance control mechanism and/or other control mechanisms for the radiating structure 820. The instruction from the antenna controller 812 acts to control generation of radiation beams, in which a radiation beam may be specified by antenna parameters such as beam width, transmit angle, transmit direction and so forth.

The transceiver 810 prepares a signal for transmission, such as a signal for a radar device, in which the signal is defined by modulation and frequency. The signal is received by each unit cell element 828 of the radiating array structure 826 and the phase of the radiating array structure 826 is adjusted by the antenna controller 812. In some implementations, transmission signals are received by a portion, or subarray, of the radiating array structure 826. The radiating array structure 826 may be applicable to many applications, including radar and cellular antennas. The subject technology considers an application in autonomous vehicles, such as an on-board sensor to detect objects in the environment of the vehicle. Alternate implementations may use the subject technology for wireless communications, medical equipment, sensing, monitoring, and so forth. Each application type incorporates designs and configurations of the elements, structures and modules described herein to accommodate their needs and goals.

In the antenna system 800, a signal is specified by the antenna controller 812, which may be in response to prior signals processed by an Artificial Intelligence (AI) module that is communicably coupled to the antenna system 800 over the communication bus 83. In other implementations, the signal may be provided from the interface-to-sensor fusion 804. In still other implementations, the signal may be based on program information from the memory storage unit 828. There are a variety of considerations to determine the beam formation, in which this information is provided to the antenna controller 812 to configure the various unit cell elements 828 of the radiating array structure 826. The transmission signal controller 808 generates the transmission signal and provides the transmission signal to the feed distribution module 816, which provides the signal to transmission array structure 824 and radiating array structure 826.

When the transmission signal is provided to the radiating structure 820, such as through a coaxial cable or other connector, the transmission signal propagates through the feed distribution module 816 to the transmission array structure 824 through which the transmission signal radiates to the radiating array structure 826 for transmission through the air. As depicted in FIG. 8, the transmission array structure 824 and the radiating array structure 826 are arranged side-by-side, however, the physical arrangement of the radiating array structure 826 relative to the transmission array structure 824 may be different depending on implementation.

The implementation illustrated in FIG. 8 enables phase shifting of radiating signals from radiating array structure 826. This enables a radar unit to scan a large area with the radiating array structure 826. For vehicle applications, sensors seek to scan the entire environment of the vehicle. These then may enable the vehicle to operate autonomously, or may provide driver assist functionality, including warnings and indicators to the driver, and controls to the vehicle. The subject technology in the present disclosure is a dramatic contrast to the traditional complex systems incorporating multiple antennas controlled by digital beam forming. The subject technology increases the speed and flexibility of conventional systems, while reducing the footprint and expanding performance.

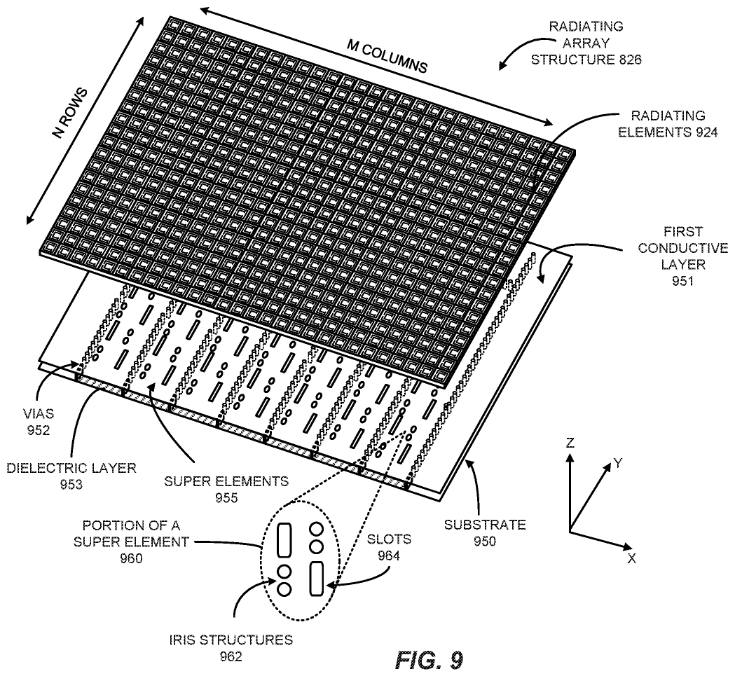

FIG. 9 illustrates an exploded view of the radiating structure 820, according to some implementations of the subject technology. Not all of the depicted components may be used, however, and one or more implementations may include additional components not shown in the figure. Variations in the arrangement and type of the components may be made without departing from the scope of the claims set forth herein. Additional components, different components, or fewer components may be provided.

The radiating structure 820 includes the radiating array structure 826 positioned proximate to the transmission array structure 824. As illustrated, the radiating array structure 826 is positioned above the transmission array structure 824 in the z-direction, which is the direction in which signals radiate through the radiating array structure 826. The radiating array structure 826 may be coupled to the transmission array structure 824 having one or more layers therebetween. In some implementations, the layering between the various layers of the radiating structure 820 includes an air gap formed therebetween.

The radiating array structure 826 is made up of a pattern of radiating elements 924, such as unit cell elements 828 of FIG. 8. The radiating elements 924 may be meta-structures or other metamaterial-based radiating structures. The radiating array structure 826 is organized into M columns and N rows; however, the specification arrangement of the radiating elements 924 may vary from the illustrated arrangement without departing from the scope of the present disclosure. The radiating array structure 826 may include a periodic and uniform arrangement of radiating elements 924 positioned to interact with the super elements 955. The radiating elements 924 are positioned with respect to the super elements 955 of the transmission array structure 824. In some implementations, the radiating array structure 826 includes an antenna array portion having a subset number of the radiating elements 924 that are aligned with the super element 955. The alignment can be observed by dashed lines that delineate the super element 955 on the conductive surface of the first conductive layer 951. In this respect, the corresponding subarray of radiating elements 924 interacts with the super element 955 for transmission of signals.

Positioned proximate the radiating elements 924 is a substrate layer 950 of super elements 955, in which each super element is a slotted structure having a dielectric material sandwiched between two conductive layers. For example, a portion of a superelement is illustrated, which includes iris structures 962 positioned proximate to slots 964. As illustrated, vias 952 are positioned through the dielectric layer 953 and conductive layers (e.g., 951) to form paths for propagation of electromagnetic waves through the super elements 955. The electromagnetic waves radiate through the slots 964 to the radiating elements 924.

In operation, the radiating array structure 826 receives a transmission signal from the slots of the super element 955. The transmission signal from the super element 955, for example, is received by the subarray of radiating elements 924 and is radiated over the air. In some implementations, the super elements of the transmission array structure 824 are positioned lengthwise along the x-direction, and enables scanning in that direction. In some examples, the x-direction corresponds to the azimuth or horizontal direction of the radar; the y-direction corresponds to the elevation direction; and the z-direction corresponds to the direction of the radiated signal.

In some implementations, the iris structures 962 are, or at least include, vias formed through all or a portion of the layers of the substrate layer 950. The iris structures 962 may have a cylindrical shape, but may have other shapes, such as a rectangular prism shape. The vias are disposed with a conductive material and may serve as an impedance to the electromagnetic wave propagating through the super elements (e.g., 955).

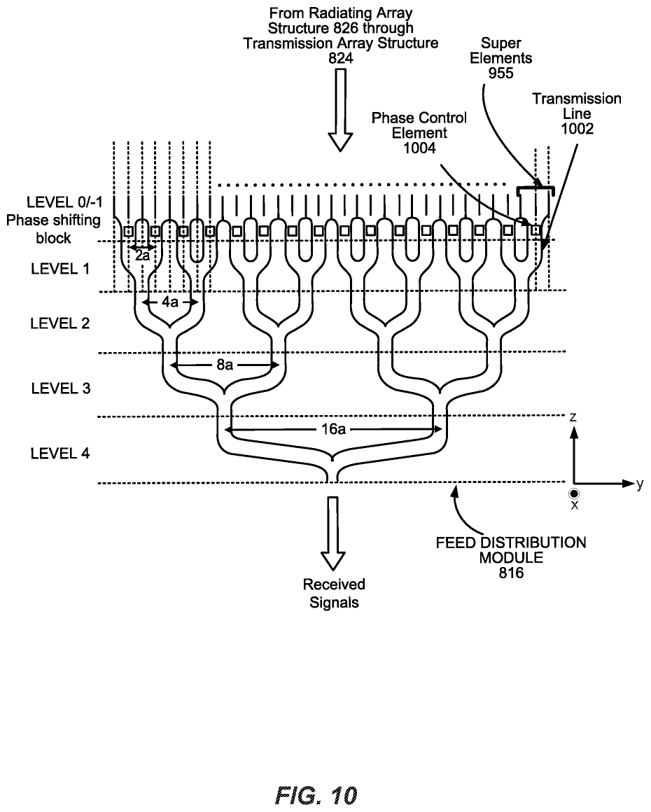

FIG. 10 illustrates a cross-sectional schematic diagram of the feed distribution module 816 that provides a corporate feed propagating return signals received from superelements (e.g., 855) to an antenna system (e.g., 800) for processing, according to some implementations of the subject technology. In this implementation, the feed distribution module 816 is a type of power divider circuit. The input signaling is fed in through the various paths. This configuration is an example and is not meant to be limiting to the specific structure disclosed.

Within the feed distribution module 816 is a network of paths, in which each of the division points is identified according to a division level. As depicted in FIG. 10, the feed distribution module 816 includes a first level of transmission lines (depicted as LEVEL 0), a second level of transmission lines (depicted as LEVEL 1), a third level of transmission lines (depicted as LEVEL 2), a fourth level of transmission lines (depicted as LEVEL 3), and a fifth level of transmission lines (depicted as LEVEL 4). The distance between two paths originating from a common division point may be fixed for other paths on a same level, but the distance between paths on other levels may be different. For example, the transmission lines split off from a common division point on LEVEL 1 may be separated by a first distance (depicted as 2a), whereas, the transmission lines split off from a common division point on LEVEL 2 may be separated by a second distance (depicted as 4a), which is greater than the first distance (or 2a). In another example, the transmission lines split off from a common division point on LEVEL 3 may be separated by a third distance (depicted as 8a) that is greater than the second distance (or 4a), whereas the transmission lines split off from a common division point on LEVEL 4 may be separated by a fourth distance (depicted as 16a), which is greater than the third distance (or 8a). In this implementation, the paths have similar dimensions; however, the size of the paths may be configured differently to achieve a desired transmission and/or radiation result. The transmission lines of the feed distribution module 816 may reside in a substrate of the radiating structure 820.

In some aspects, the transmission lines on LEVEL 0 include phase shifting blocks on respective transmission line paths. The feed distribution module 816 may include a phase control element 1004 on each transmission line on LEVEL 0. In some implementations, the phase control element 1004 is incorporated into a transmission line 1002. In some aspects, the phase control element 1004 may be positioned otherwise within the paths leading to one or more super elements. For example, the phase control element 1004 is coupled to super elements 955. There are a variety of ways to couple the phase control element 1004 to one or more transmission lines. As illustrated, the other paths of LEVEL 1 have reactance control mechanisms that may be the same as the phase control element 1004.

In some implementations, the phase control element 1004 acts to change the reactance of the transmission line 1002, resulting in a change to the signal propagating through the transmission line 1002 to the super elements 955. In a receiving operation, the transmission array structure 824 receives input signals from the radiating array structure 826, which propagate through the network of paths of the feed distribution module 816 and to a radar electronic control unit (not shown) for processing.

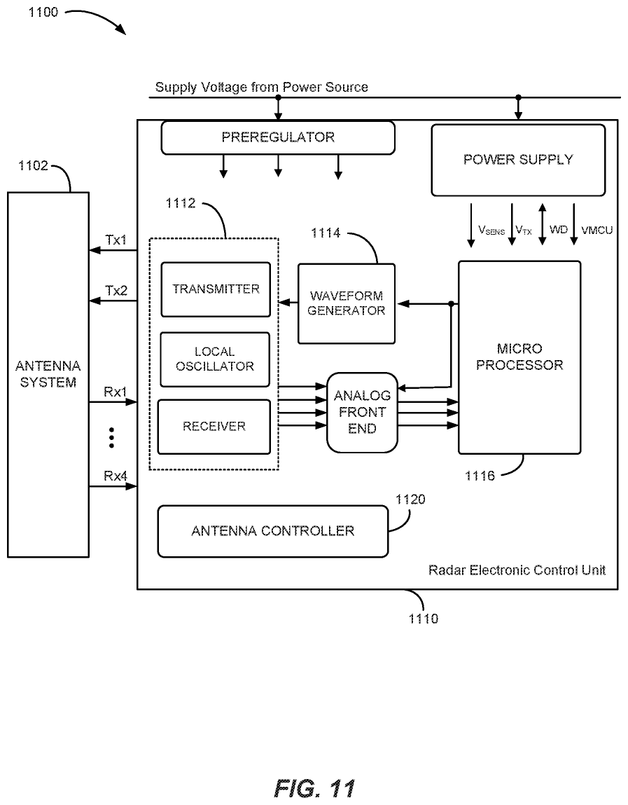

FIG. 11 illustrates a radar system 1100 having an antenna system 1102 and a control system 1110, according to various implementations of the subject technology. The control system 1110 includes a transceiver 1112, a waveform generator 1114, a microprocessor 1116 and an antenna controller 1120. Not all of the depicted components may be used, however, and one or more implementations may include additional components not shown in the figure. Variations in the arrangement and type of the components may be made without departing from the scope of the claims set forth herein. Additional components, different components, or fewer components may be provided.

In some implementations, the antenna system 1102 is a meta-structure-based antenna array having multiple radiating elements, in which at least one of the radiating elements has a reactance control mechanism to change reactance of a unit cell element in a radiating array structure (e.g., the radiating array structure 826). The reactance control mechanism may be a varactor or variable capacitor diode that changes the capacitance of the unit cell. The waveform generator 1114 prepares the signals for transmission, such as to prepare Frequency Modulated Continuous Wave (FMCW) signals. The microprocessor 1116 can control operation of various functions, including power control of the power supply and/or the pre-regulator, the waveform generator 1114, the transceiver 1112, transmit ports (Tx1, Tx2) and receive ports (Rx1 . . . Rx4). For example, the microprocessor 1116 can control the processing of raw data received as input signals through the antenna system 1102. In some implementations, the control system 1110 performs digital processing to determine the amount of intensity of the received signals and execute a control action to the antenna system 1102 as to the location of a RF beam onto a target.

The receive antenna portion of the antenna system 1102 may be controlled by the antenna controller 1120. The antenna controller 1120 is, or includes at least a portion of, the antenna controller 812 of FIG. 8. In some implementations, the antenna controller 1120 implements a process for directing the main lobe and side lobes of the radiation pattern of the receive antenna. For example, the process may correspond to the process 700 described in FIG. 7.

It is also appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item).The phrase “at least one of does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A receive antenna array, comprising:
an array of radiating elements; and
an antenna controller coupled to the array of radiating elements and configured to:
determine one or more portions of a radiation pattern of the array of radiating elements in response to detection of an object; and
determine a directivity of a transmission from the array of radiating elements to increase gain of the transmission in a direction of the object based on the one or more portions of the radiation pattern,
wherein the one or more portions includes a first portion of the radiation pattern that corresponds to a main lobe, a second portion of the radiation pattern that corresponds to at least one side lobe portion and a third portion of the radiation pattern that corresponds to an overlapping area of the main lobe and the at least one side lobe.

2. The receive antenna array of claim 1, wherein the first portion of the radiation pattern has a first radial distance from the array of radiating elements.

3. The receive antenna array of claim 2, wherein the second portion of the radiation pattern has a second radial distance from the array of radiating elements.

4. The receive antenna array of claim 3, wherein the third portion of the radiation pattern has a third radial distance from the array of radiating elements.

5. The receive antenna array of claim 4, wherein second radial distance is greater than the third radial distance.

6. The receive antenna array of claim 5, wherein first radial distance is greater than the second radial distance.)

7. A method of directing radar transmissions, comprising:
receiving a return signal at an array of antenna elements;
determining an angle of arrival and a range of the return signal reflected by an object; and
controlling a directivity of the array of antenna elements as a function of the angle of arrival and the range based at least on a radial range of the object.

8. The method of claim 7, wherein the controlling the directivity of the array of antenna elements comprises:
determining a radial range of the object measured from the array of antenna elements; and
adjusting the directivity of the array of antenna elements for the radial range.

9. The method of claim 8, further comprising:
determining that a portion of a radiation pattern of the array of antenna elements detected an object reflection; and
determining a scan step size as a function of the portion of the radiation pattern.

10. The method of claim 9, further comprising:
determining directivity of a subsequent scan step size based at least on the radial range, wherein the radiation pattern includes a main lobe portion that corresponds to a first radial range of the object, a side lobe portion that corresponds to a second radial range of the object, and an overlapping portion of the main lobe portion and the side lobe portion that corresponds to a third radial range of the object.

11. A method of detecting objects with radiation pattern directivity, comprising:
directing a main beam of a receive antenna to detect one or more return radio frequency (RF) beams that are reflected from one or more objects in an environment;
receiving the one or more return RF beams as reflections through the receive antenna;
determining which of a plurality of lobes of the receive antenna received the reflections;
adjusting a direction of at least one lobe of the plurality of lobes based on one or more properties of the reflections;
determining whether a full scan has completed; and
setting the receive antenna to an initial direction when the full scan is completed.

12. The method of claim 11, further comprising:
determining one or more of a direction or gain of one or more side lobes of the plurality of lobes.

13. The method of claim 11, further comprising:
determining whether a main lobe of the plurality of lobes received the reflections; and
adjusting a direction of a main beam emitted by the receive antenna when the reflections are determined as received by the main lobe.

14. The method of claim 13, wherein the adjusting of the direction of the main beam is performed through phase shifting operations on one or more antenna elements of the receive antenna.

15. The method of claim 13, further comprising:
determining one or more of a range, velocity or angle of arrival of the one or more return RF beams,
wherein the adjusting of the direction of the main beam is performed based at least on the determined range, velocity or angle of arrival of the reflections.

16. The method of claim 15, further comprising:
determining whether to direct a main lobe of the receive antenna or an overlapped region of the receive antenna based on a comparison of the determined range to a predetermined range threshold;
directing the overlapped region of the receive antenna toward a direction of the object when the determined range is lesser than the predetermined range threshold; and
directing the main lobe of the receive antenna toward the direction of the object when the determined range is greater than the predetermined range threshold.

17. The method of claim 11, further comprising:
determining whether side lobes of the plurality of lobes received the reflections; and
adjusting a direction of a main beam and resultant side lobe directions emitted by the receive antenna when the reflections are determined as received by the side lobes.

18. The method of claim 17, wherein the adjusting the direction of a main beam and the resultant side lobe directions comprises adjusting alignment of at least one side lobe with a direction of the object.

19. The method of claim 11, further comprising:
determining whether an overlapped area of a main lobe and at least one side lobe of the plurality of lobes received the reflections; and
adjusting a direction of a main beam and resultant side lobe directions emitted by the receive antenna when the reflections are determined as received by the overlapped area of the main lobe and the at least one side lobe.

20. The method of claim 19, wherein the adjusting the direction of the main beam and the resultant side lobe directions comprises adjusting alignment of the overlapped area of the main lobe and the at least one side lobe with a direction of the object.)
